(19) United States
(12) Patent Application Publication
(10) Pub. No.: US 2023/0198018 A1
(43) Pub. Date: Jun. 22, 2023

(54) BATTERY

(71) Applicant: ZHUHAI COSMX BATTERY CO., LTD., Zhuhai (CN)

(72) Inventors: Hai WANG, Zhuhai (CN); Yingdi MU, Zhuhai (CN); Changan ZENG, Zhuhai (CN); Rude GUO, Zhuhai (CN); Suli LI, Zhuhai (CN); Junyi LI, Zhuhai (CN); Dayan QIAN, Zhuhai (CN)

(73) Assignee: ZHUHAI COSMX BATTERY CO., LTD., Zhuhai (CN)

(21) Appl. No.: 18/067,913

(22) Filed: Dec. 19, 2022

(30) Foreign Application Priority Data
Dec. 17, 2021 (CN) 202111552792.X

(51) Int. Cl. H01M 10/0567; H01M 10/0569; H01M 10/0525; H01M 10/0568

(52) U.S. Cl. CPC H01M 10/0567; H01M 10/0569; H01M 10/0525; H01M 10/0568; H01M 2004/028

(57) ABSTRACT

Disclosed is a battery, including a positive electrode plate, a negative electrode plate, a separator, and a non-aqueous electrolyte solution. The non-aqueous electrolyte solution includes a non-aqueous organic solvent, an electrolyte salt, and an additive. The non-aqueous organic solvent includes EMC and/or EP, and the additive includes LiPO₂F₂. The battery in the present disclosure has a small direct current internal resistance in a high SOC, which may greatly prolong a constant current charging time of the battery during a charging process, thereby achieving an effect of fast charging. Moreover, consumption of the electrolyte salt in the electrolyte solution may be significantly reduced due to introduction of LiPO₂F₂, so that fast charging performance of the battery is not decreased during entire service life.

### CROSS-REFERENCE TO RELATED APPLICATIONS

This application claims priority to Chinese Patent Application No. 202111552792.X, filed on Dec. 17, 2021, which is hereby incorporated by reference in its entirety.

### TECHNICAL FIELD

The present disclosure relates to a battery, and belongs to the field of battery technologies.

### BACKGROUND

With advantages of high operating voltages, high specific energy density, long cycle life, low self-discharge rates, no memory effects, and low environmental pollution, lithium-ion batteries have been widely used in various consumer electronics markets, and are desirable power sources for future electric vehicles and various motor-driven tools. However, lithium-ion batteries usually have a relatively long charging time, and most of them require one hour or more, which severely restricts experience of consumers. Particularly in the field of electric vehicles, compared with conventional gasoline vehicles that require a maximum of 10 minutes for refueling, electric vehicles require one hour or more for a full charge, which severely restricts use and promotion of electric vehicles.

### SUMMARY

To shorten a charging time of a battery and widen its application field, the present disclosure provides a battery with fast charging performance, and a time required for charging the battery to an SOC of 80% at a rate of 3 C or more is less than or equal to 20 minutes.

Objects of the present disclosure are achieved through the following technical solutions:

A battery is provided, including a positive electrode plate, a negative electrode plate, a separator, and a non-aqueous electrolyte solution. The non-aqueous electrolyte solution includes a non-aqueous organic solvent, an electrolyte salt, and an additive.

The non-aqueous organic solvent includes ethyl methyl carbonate (EMC) and/or ethyl propionate (EP), and the additive includes LiPO₂F₂.

A mass percentage of content of the EMC and/or the EP in a total mass of the non-aqueous organic solvent is A wt %. A mass percentage of content of the LiPO₂F₂ in a total mass of the non-aqueous electrolyte solution is B wt %.

A thickness of the negative electrode plate is C, and measured in units of μm.

A, B, and C satisfy the following relational expression: A+100×B−C≥0.

A discharge direct current internal resistance of the battery at 25° C. in an SOC (state of charge) of 50% is D, a discharge direct current internal resistance of the battery at 25° C. in an SOC of 80% is E, and D and E satisfy the following relational expression: E/D≤2.

Usually, a charging mode of a battery is constant current and constant voltage charging. Due to a large direct current internal resistance of the battery in a high SOC, polarization of the battery during charging is large. Especially during charging at a large rate (such as a rate of 2 C or larger), the battery quickly reaches a charging cut-off voltage. Therefore, the charging quickly changes from a constant current charging stage to a constant voltage charging stage, which greatly prolongs a charging time of the battery. The battery provided in the present disclosure has a small discharge direct current internal resistance, especially in a high SOC (for example, an SOC of 80%), which can significantly improve charging performance of the battery.

According to the present disclosure, the mass percentage of the content of the EMC and/or the EP in the total mass of the non-aqueous organic solvent is A wt %, where A wt %≥20 wt %, that is, the mass percentage A wt % of the content of the EMC and/or EP in the total mass of the non-aqueous organic solvent is greater than or equal to 20 wt %, for example, 80 wt %≥A wt %≥20 wt %. For example, A wt % is 20 wt %, 25 wt %, 30 wt %, 35 wt %, 40 wt %, 45 wt %, 50 wt %, 55 wt %, 60 wt %, 65 wt % %, 70 wt %, 75 wt %, or 80 wt %.

According to the present disclosure, the non-aqueous organic solvent further includes one or more of the following solvents: ethylene carbonate (EC), propylene carbonate (PC), dimethyl carbonate, diethyl carbonate, propyl acetate, n-butyl acetate, isobutyl acetate, n-amyl acetate, isoamyl acetate, propyl propionate (PP), methyl butyrate, or ethyl n-butyrate.

According to the present disclosure, the electrolyte salt is selected from at least one of a lithium salt, a sodium salt, a magnesium salt, or the like.

According to the present disclosure, the lithium salt is selected from at least one of lithium hexafluorophosphate or lithium bis(fluorosulfonyl)imide.

According to the present disclosure, a content of the electrolyte salt in the non-aqueous electrolyte solution ranges from 1 mol/L to 2 mol/L.

According to the present disclosure, conductivity of the non-aqueous electrolyte solution measured at 25° C. is greater than or equal to 7 mS/cm.

According to the present disclosure, the mass percentage of the content of the LiPO₂F₂ in the total mass of the non-aqueous electrolyte solution is B wt %, where B wt %≤1 wt %, that is, the mass percentage B wt % of the content of the LiPO₂F₂ in the total mass of the non-aqueous electrolyte solution is less than or equal to 1 wt %, for example, 0.05 wt %≤B wt %≤1 wt %. For example, B wt % is 0.05 wt %, 0.1 wt %, 0.15 wt %, 0.2 wt %, 0.3 wt %, 0.4 wt %, 0.5 wt %, 0.6 wt %, 0.7 wt %, 0.8 wt %, 0.9 wt %, or 1 wt %.

In the present disclosure, addition of the LiPO₂F₂ to the non-aqueous electrolyte solution causes a decrease in conductivity of the non-aqueous electrolyte solution. For example, a decrease in conductivity of the non-aqueous electrolyte solution caused by addition of LiPO₂F₂ to the non-aqueous electrolyte solution is less than or equal to 1 mS/cm, that is, a value of a conductivity change of the non-aqueous electrolyte solution before and after the addition of LiPO₂F₂ to the non-aqueous electrolyte solution is less than or equal to 1 mS/cm.

It is found through research that the following reaction exists in the non-aqueous electrolyte solution (LiPF₆ is used as an example):

LiPF₆+2H₂O→LiPO₂F₂+4HF

When there is a specific amount of LiPO₂F₂ in the non-aqueous electrolyte solution, the reaction is inhibited from proceeding rightward, reducing consumption of a lithium salt in the non-aqueous electrolyte solution after the battery is used. This may significantly reduce performance degradation of the battery after long-term cycling. To be specific, an amount of LiPO₂F₂ added to the non-aqueous electrolyte solution is controlled in the present disclosure, so that a low-impedance SEI (solid electrolyte interphase) film can be formed on a surface of a negative electrode, and further, consumption of the lithium salt in the non-aqueous electrolyte solution during a long-term cycle process can be suppressed, thereby ensuring fast charging performance over entire service life of the battery. However, when an excessive amount of LiPO₂F₂ is added to the non-aqueous electrolyte solution, conductivity of the non-aqueous electrolyte solution decreases significantly (by more than 1 mS/cm), which causes significant deterioration of fast charging performance of the battery.

According to the present disclosure, the discharge direct current internal resistance D of the battery at 25° C. in the SOC of 50% is less than or equal to 65 mΩ, the discharge direct current internal resistance E of the battery at 25° C. in the SOC of 80% is less than or equal to 100 mΩ, and D and E satisfy the following relational expression: E/D≤2.

According to the present disclosure, D and E satisfy the following relational expression: 0.5≤E/D≤2. For example, D and E satisfy the following relational expression: 1≤E/D≤1.8. For example, D and E satisfy: 1.2≤E/D≤1.6.

According to the present disclosure, the non-aqueous electrolyte solution may further includes one or more of the following additives: vinylene carbonate, vinyl ethylene carbonate, fluoroethylene carbonate, ethylene sulphite, methylene methanedisulfonate, ethylene sulfate, succinonitrile, glutaronitrile, adiponitrile, pimelic dinitrile, suberonitrile, sebaconitrile, 1,3,6-hexanetrinitrile, 1,2-bis(2-cyanoethoxy)ethane, 3-methoxypropionitrile, 1,3-propanesultone, or propenyl-1,3-sultone.

According to the present disclosure, the positive electrode plate includes a positive electrode current collector and a positive electrode active material layer coated on a surface of either or both sides of the positive electrode current collector, and the positive electrode active material layer includes a positive electrode active material, a conductive agent, and a binder.

According to the present disclosure, the negative electrode plate includes a negative electrode current collector and a negative electrode active material layer coated on a surface of either or both sides of the negative electrode current collector, and the negative electrode active material layer includes a negative electrode active material, a conductive agent, and a binder.

According to the present disclosure, mass percentages of components in the positive electrode active material layer are as follows: 80-99.8 wt % for the positive electrode active material, 0.1-10 wt % for the conductive agent, and 0.1-10 wt % for the binder.

For example, mass percentages of components in the positive electrode active material layer are as follows: 90-99.6 wt % for the positive electrode active material, 0.2-5 wt % for the conductive agent, and 0.2-5 wt % for the binder.

According to the present disclosure, mass percentages of components in the negative electrode active material layer are as follows: 80-99.8 wt % for the negative electrode active material, 0.1-10 wt % for the conductive agent, and 0.1-10 wt % for the binder.

For example, mass percentages of components in the negative electrode active material layer are as follows: 90-99.6 wt % for the negative electrode active material, 0.2-5 wt % for the conductive agent, and 0.2-5 wt % for the binder.

According to the present disclosure, the conductive agent is selected from at least one of conductive carbon black, acetylene black, Ketjen black, conductive graphite, conductive carbon fiber, carbon nanotube, metal powder, or carbon fiber.

According to the present disclosure, the binder is selected from at least one of sodium carboxymethyl cellulose, styrene-butadiene latex, polytetrafluoroethylene, or polyethylene oxide.

According to the present disclosure, the negative electrode active material is selected from at least one of natural graphite, artificial graphite, hard carbon, soft carbon, mesophase microspheres, a silicon-oxygen composite material, or a silicon-carbon negative electrode material.

According to the present disclosure, the positive electrode active material is selected from one or more of a layered-lithium transition metal composite oxide, lithium manganate, or a ternary material mixed with lithium cobaltate. The layered-lithium transition metal composite oxide has a chemical formula of Li₁₊ₓNi_{y}Co_{z}M_{(1-y-z)}O₂, where −0.1≤x≤1, 0≤y≤1, 0≤z≤1, and 0≤y+z≤1. M is one or more of Mg, Zn, Ga, Ba, Al, Fe, Cr, Sn, V, Mn, Sc, Ti, Nb, Mo, or Zr.

According to the present disclosure, the thickness C of the negative electrode plate is preferably less than or equal to 150 μm, for example, less than or equal to 120 μm, and less than or equal to 100 μm. For example, the thickness C of the negative electrode plate is 20 μm, 30 μm, 40 μm, 50 μm, 60 μm, 70 μm, 80 μm, 90 μm, 100 μm, 110 μm, 120 μm, 130 μm, 140 μm or 150 μm.

According to the present disclosure, the thicknesses of the negative electrode plate and the positive electrode plate have the following relationship: a ratio of the thickness of the positive electrode plate to the thickness of the negative electrode plate is (0.93−1.48):1.

According to the present disclosure, the battery is a lithium-ion battery, a sodium-ion battery, or a magnesium-ion battery.

The inventor of the present disclosure has found through keen research that fast charging performance of a battery is associated with a migration speed of ions (such as lithium ions) in a non-aqueous electrolyte solution, a diffusion speed of ions (such as lithium ions) in an SEI film, and a thickness of a negative electrode plate. On this basis, the inventor of the present disclosure has unexpectedly found that a battery with a fast charging capability may be obtained by adjusting a mass percentage A wt % of content of EMC and/or EP in a total mass of the non-aqueous organic solvent, a mass percentage B wt % of content of LiPO₂F₂ in a total mass of the non-aqueous electrolyte solution, and a thickness C of the negative electrode plate to satisfy the following relational expression: A+100×B−C≥0, and by adjusting D and E to meet the following relational expression: E/D≤2, where a discharge direct current internal resistance of the battery at 25° C. in an SOC of 50% is D, and a discharge direct current internal resistance of the battery at 25° C. in an SOC of 80% is E. In this way, a time required for charging the battery to an SOC of 80% at a rate of 3 C or more may be less than or equal to 20 minutes.

The present disclosure has the following beneficial effects:

The present disclosure provides a battery. The battery in the present disclosure has a small direct current internal resistance in a high SOC, which may greatly prolong a constant current charging time of the battery during a charging process, thereby achieving an effect of fast charging. Moreover, consumption of a lithium salt in a non-aqueous electrolyte solution may be significantly reduced due to introduction of LiPO₂F₂, so that fast charging performance of the battery is not decreased during entire service life.

### DETAILED DESCRIPTION OF THE EMBODIMENTS

The following further describes the present disclosure in detail with reference to specific examples. It should be understood that the following examples are only intended to illustrate and explain the present disclosure, and shall not be construed as a limitation on the protection scope of the present disclosure. All technologies implemented based on the foregoing content of the present disclosure shall fall within the intended protection scope of the present disclosure.

Experimental methods used in the following examples are all conventional methods unless otherwise specified, and reagents, materials, and the like that are used in the following examples may be all obtained from commercial sources unless otherwise specified.

To make objectives, technical solutions, and advantages of the present disclosure clearer, the following clearly describes the technical solutions in the embodiments of the present disclosure with reference to the embodiments of the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

It may be understood that the battery in the present disclosure includes a negative electrode plate, an electrolyte solution, a positive electrode plate, a separator, and an outer packaging. The positive electrode plate, the separator, and the negative electrode plate are stacked to obtain a cell, or the positive electrode plate, the separator, and the negative electrode plate are stacked and then rolled up to obtain a cell. The cell is placed in the outer packaging, and the electrolyte solution is injected into the outer packaging, so that the battery of the present disclosure may be obtained.

### Examples 1 to 12 and Comparative Examples 1 to 6

Batteries in Examples 1 to 12 and Comparative Examples 1 to 6 were prepared through the following steps.

(1) Preparation of a Positive Electrode Plate

Positive electrode active materials lithium cobaltate (LiCoO₂), polyvinylidene fluoride (PVDF), SP (super P), and carbon nanotubes (CNT) were mixed at a mass ratio of 96:2:1.5:0.5, and were added with N-methylpyrrolidone (NMP). The mixture was stirred under action of a vacuum mixer until a mixed system became uniform fluid positive electrode active slurry. Both surfaces of an aluminum foil were coated evenly with the positive electrode active slurry. The coated aluminum foil was dried, then rolled, and cut, to obtain a required positive electrode plate.

(2) Preparation of a Negative Electrode Plate

Negative electrode active materials graphite, sodium carboxymethyl cellulose (CMC-Na), styrene-butadiene rubber, conductive carbon black (SP), and single-walled carbon nanotubes (SWCNTs) were mixed at a mass ratio of 96:1.5:1.5:0.9:0.1, and were added with deionized water. The mixture was stirred under action of a vacuum mixer to obtain negative electrode active slurry. Both sides of a copper foil were coated evenly with the negative electrode active slurry. The coated copper foil was dried at room temperature, then transferred to an oven for drying at 80° C. for 10 hours, followed by cold pressing and slitting to obtain a negative electrode plate.

(3) Preparation of an Electrolyte Solution

In a glove box filled with argon gas (H₂O<0.1 ppm, O₂<0.1 ppm), non-aqueous organic solvents were mixed evenly at a specific mass ratio, and then were quickly added with 1 mol/L of fully dried lithium hexafluorophosphate (LiPF₆). After dissolution in the non-aqueous organic solvent, which was added with fluoroethylene carbonate with 5 wt %, 1,3-propane sultone with 3 wt %, 1,3,6-hexanetricarbonitrile with 1 wt % of a total mass of the electrolyte solution, and added with LiPO₂F₂ (a specific amount was described in Table 1). The mixture was stirred evenly, to obtain a required electrolyte solution after water content and free acid tests were passed.

(4) Preparation of the Battery

The positive electrode plate in step (1), the negative electrode plate in step (2), and a separator were stacked in an order of the positive electrode plate, the separator, and the negative electrode plate, and then were rolled up to obtain a cell. The cell was placed in outer packaging aluminum foil, and the electrolyte solution in step (3) was injected into the outer packaging, and the battery was obtained through processes of vacuum packaging, standing, formation, shaping, sorting, and the like. A charging and discharging range of the battery in the present disclosure ranges from 3.0 V to 4.4 V.

The following tests were performed on batteries obtained in the Examples and Comparative Examples respectively, and test results are shown in Table 2, Table 4, and Table 6.

1 Cycle Performance Test

The battery was charged and discharged for 100 cycles within a charge and discharge cut-off voltage range at a rate of 2 C at 25° C. A discharge capacity of the first cycle and a discharge capacity of the 100^{th} cycle were tested. The discharge capacity of the 100^{th} cycle was divided by the discharge capacity of the first cycle to obtain cycle capacity retention.

2. Charging Time Test

(1) At 25° C., the battery was charged with a constant current of 0.5 C until a cut-off voltage is reached, and then charged with a constant voltage until a charge cut-off current reaches 0.1 C. The battery was left standing for 2 hours, and discharged with 0.5 C until a cut-off voltage is reached. After 3 cycles, the highest discharge capacity was record as Q₀.

(2) At 25° C., the battery was charged with a constant current and a constant voltage at a rate of 3 C, and a charge cut-off current was 0.02 C. A capacity Q₁ with a charging time of 20 minutes was recorded.

(3) A ratio of Q₁/Q₀×100% was calculated to check whether the ratio was greater than or equal to 80%.

3. Discharge Direct Current Internal Resistance (D) Test at 25° C. in an SOC of 50%

(1) a. At 25° C., the battery was charged with a constant current of 0.2 C until a cut-off voltage is reached, and then charged with a constant voltage until a charge cut-off current reaches 0.05 C. The battery was left standing for 10 minutes, and then discharged with a constant current of 0.2 C until a cut-off voltage is reached, and was left standing for 10 minutes, and an initial discharge capacity C₀ was recorded. b. At 25° C., the battery was charged with a constant current of 0.2 C until a cut-off voltage is reached, and then charged with a constant voltage until a charge cut-off current reached 0.05 C, and was left standing for 10 minutes. c. At 25° C., the battery was discharged with a constant current of 0.2 C, with a discharge capacity of 50% of C₀.

(2) The battery was discharged with 0.2 C for 10 s to obtain a discharge terminal voltage, which was recorded as U₁. The current was switched to 1 C to discharge the battery with 1 C for is to obtain a discharge terminal voltage, which was recorded as U₂, so as to calculate a DCIR (DC Internal Resistance). A calculation method of the DCIR was as follows: DCIR=(U₁−U₂)/(1−0.2)C.

4. Discharge Direct Current Internal Resistance (E) Test at 25° C. in an SOC of 80%

(1) a. At 25° C., the battery was charged with a constant current of 0.2 C until a cut-off voltage is reached, and then charged with a constant voltage until a charge cut-off current reached 0.05 C. The battery was left standing for 10 minutes, and then discharged with a constant current of 0.2 C until a cut-off voltage is reached, and was left standing for 10 minutes, and an initial discharge capacity C₀ was recorded. b. At 25° C., the battery was charged with a constant current of 0.2 C until a cut-off voltage is reached, and then charged with a constant voltage until the charge cut-off current reached 0.05 C. The battery was left standing for 10 min. c. At 25° C., the battery was discharged with a constant current of 0.2 C, and the discharge capacity was 20% of C₀.

(2) The battery was discharged with 0.2 C for 10 s to obtain a discharge terminal voltage, which was recorded as U₁. The current was switched to 1 C to discharge the battery with 1 C for 30 s to obtain a discharge terminal voltage, which was recorded as U₂, so as to calculate a DCIR. A calculation method of the DCIR is as follows: DCIR=(U₁−U₂)/(1−0.2)C.

TABLE 1
Composition and performance test results of batteries in the Examples and Comparative Examples

| | | | | | | DC internal | DC internal | |
|---|---|---|---|---|---|---|---|---|
| | Electrolyte | | | | | resistance D in | resistance E in | |
| | solvents (mass | | | | A + 100 × | SOC of 50% | SOC of 80% | |
| Number | ratio) | A | B | C | B − C | (mΩ) | (mΩ) | E/D |
| Comparative | EC/PC/PP = | 0 | 0.5 | 70 | −20 | 43.88 | 99.01 | 2.26 |
| Example 1 | 20/15/65 | | | | | | | |
| Comparative | EC/PC/EP = | 65 | 0.8 | 130 | 15 | 32.61 | 77.54 | 2.38 |
| Example 2 | 20/15/65 | | | | | | | |
| Comparative | EC/PC/PP/EP = | 20 | 0.5 | 80 | −10 | 43.80 | 69.11 | 1.58 |
| Example 3 | 20/15/45/20 | | | | | | | |
| Example 1 | EC/PC/PP/EP = | 35 | 0.8 | 80 | 35 | 42.64 | 67.39 | 1.58 |
| | 20/15/30/35 | | | | | | | |
| Example 2 | EC/PC/EP = | 65 | 0.8 | 80 | 65 | 42.19 | 66.63 | 1.58 |
| | 20/15/65 | | | | | | | |
| Example 3 | EC/PC/EP = | 65 | 0.5 | 60 | 55 | 32.19 | 46.63 | 1.45 |
| | 20/15/65 | | | | | | | |
| Example 4 | EC/PC/PP/EMC = | 20 | 0.8 | 80 | 20 | 42.54 | 67.65 | 1.59 |
| | 20/15/45/20 | | | | | | | |
| Example 5 | EC/PC/PP/EMC = | 35 | 0.8 | 90 | 25 | 41.57 | 62.92 | 1.51 |
| | 20/15/30/35 | | | | | | | |
| Example 6 | EC/PC/EMC = | 65 | 0.8 | 100 | 45 | 40.74 | 61.98 | 1.52 |
| | 20/15/65 | | | | | | | |
| Example 7 | EC/PC/PP/EP = | 40 | 0.8 | 80 | 40 | 40.09 | 61.13 | 1.53 |
| | 15/15/30/40 | | | | | | | |

A wt % is a mass percentage of content of EMC and/or EP in a total mass of the non-aqueous organic solvent.
B wt % is a mass percentage of content of LiPO₂F₂ in a total mass of the non-aqueous electrolyte solution.
C is a thickness of the negative electrode plate in units of μm.

TABLE 2
Performance test results of batteries in
the Examples and Comparative Examples

| | Whether a charge capacity is | |
|---|---|---|
| | greater than or equal to 80% | Capacity retention |
| | after a battery is charged | after 100 cycles at |
| | with 3 C for 20 minutes | room temperature |
| Comparative | No | 62.46% |
| Example 1 | | |
| Comparative | No | 73.55% |
| Example 2 | | |
| Comparative | No | 71.71% |
| Example 3 | | |
| Example 1 | Yes | 91.18% |
| Example 2 | Yes | 91.79% |
| Example 3 | Yes | 91.79% |
| Example 4 | Yes | 92.09% |
| Example 5 | Yes | 92.27% |
| Example 6 | Yes | 91.96% |
| Example 7 | Yes | 92.50% |

It may be seen from Table 2 that when A+100×B−C≥0 and E/D≤2, the obtained charging performance of the battery is significantly improved, the charge capacity is greater than or equal to 80% after the battery is charged with 3 C for 20 minutes, and the capacity retention after 100 cycles at room temperature is greater than 90%. When A+100×B−C<0 or E/D>2, the obtained charging performance of the battery is greatly reduced, and cannot meet a requirement for a charge capacity of being greater than or equal to 80% after the battery is charged with 3 C for 20 minutes, and the capacity retention after 100 cycles at room temperature is also relatively low.

TABLE 3
Composition and performance test results of batteries in the Examples and Comparative Examples

| | | | | | Value of a | | | |
|---|---|---|---|---|---|---|---|---|
| | | | | | conductivity | | | |
| | | | Electrolyte | | change of an | | | |
| | | | solution | | electrolyte solution | DC internal | DC internal | |
| | | | conductivity | | before and after | resistance D in | resistance E in | |
| | Electrolyte | | (at 25° C.) | | addition of LiPO₂F₂ | SOC of 50% | SOC of 80% | |
| Number | solvents | B | (mS/cm) | C | (mS/cm) | (mΩ) | (mΩ) | E/D |
| Example 3 | EC/PC/EP = | 0.5 | 8.6 | 60 | 0.7 | 32.19 | 46.63 | 1.45 |
| | 20/15/65 | | | | | | | |
| Comparative | EC/PC/EP = | 0 | 9.3 | 60 | 0 | 42.19 | 56.63 | 1.34 |
| Example 4 | 20/15/65 | | | | | | | |
| Comparative | EC/PC/EP = | 1.1 | 8.2 | 60 | 1.1 | 32.19 | 76.63 | 2.38 |
| Example 5 | 20/15/65 | | | | | | | |
| Comparative | EC/PC/PP/EP = | 1.1 | 6.5 | 60 | 1.2 | 70.46 | 150.8 | 2.14 |
| Example 6 | 20/15/55/10 | | | | | | | |

Remarks: Conductivity of the electrolyte solution without addition of LiPO₂F₂ is 9.3 (at 25° C.) (mS/cm), which is conductivity of the electrolyte solution in Comparative Example 4.
B wt % is a mass percentage of content of LiPO₂F₂ in a total mass of the non-aqueous electrolyte solution.
C is a thickness of the negative electrode plate in units of μm.

TABLE 4
Performance test results of batteries in the Examples and Comparative Examples

| | | | Whether a charge capacity |
|---|---|---|---|
| | Whether a charge capacity is | | obtained after a battery |
| | greater than or equal to 80% | Capacity retention | is charged with 3 C for 20 |
| | after a battery is charged | after 100 cycles at | minutes is greater than or |
| Number | with 3 C for 20 minutes | room temperature | equal to 80% after 100 cycles |
| Example 3 | Yes | 91.79% | Yes |
| Comparative | Yes | 72.87% | No |
| Example 4 | | | |
| Comparative | No | 85.71% | No |
| Example 5 | | | |
| Comparative | No | 71.7% | No |
| Example 6 | | | |

It may be seen from Table 4 that charging performance of the battery after cycles is affected without addition of LiPO₂F₂. Excessive addition also greatly reduces conductivity of the electrolyte solution and affects charging performance of the battery. Moreover, when the conductivity of the electrolyte solution is less than 7 mS/cm, charging performance of the battery also greatly decreases.

TABLE 5
Composition and performance test results of batteries in the Examples

| | | | | | | DC internal | DC internal | |
|---|---|---|---|---|---|---|---|---|
| | | | | | | resistance D in | resistance E in | |
| | Electrolyte | | | | A + 100 × | SOC of 50% | SOC of 80% | |
| Number | solvents | A | B | C | B − C | (mΩ) | (mΩ) | E/D |
| Example 8 | EC/PC/EP = | 70 | 0.8 | 60 | 90 | 30.19 | 41.63 | 1.38 |
| | 15/15/70 | | | | | | | |
| Example 9 | EC/PC/EP = | 70 | 0.8 | 90 | 60 | 37.19 | 49.63 | 1.33 |
| | 15/15/70 | | | | | | | |
| Example 10 | EC/PC/EP = | 70 | 0.8 | 110 | 40 | 52.19 | 56.63 | 1.09 |
| | 15/15/70 | | | | | | | |
| Example 11 | EC/PC/EP = | 70 | 0.8 | 130 | 20 | 56.19 | 71.63 | 1.27 |
| | 15/15/70 | | | | | | | |
| Example 12 | EC/PC/EP = | 70 | 0.8 | 148 | 2 | 62.19 | 96.63 | 1.55 |
| | 15/15/70 | | | | | | | |

A wt % is a mass percentage of content of EMC and/or EP in a total mass of the non-aqueous organic solvent.
B wt % is a mass percentage of content of LiPO₂F₂ in a total mass of the non-aqueous electrolyte solution.
C is a thickness of the negative electrode plate in units of μm.

TABLE 6
Performance test results of batteries in the Examples

| | Whether a charge | |
|---|---|---|
| | capacity is greater | Capacity |
| | than or equal to | retention after |
| | 80% after a battery | 100 cycles |
| | is charged with | at room |
| | 3C for 20 minutes | temperature |
| Example 8 | Yes | 91.36% |
| Example 9 | Yes | 92.37% |
| Example 10 | Yes | 85.71% |
| Example 11 | Yes | 85.18% |
| Example 12 | Yes | 81.79% |

It may be seen from Table 6 that with the increase of the thickness of the negative electrode plate, performance of the battery gradually decreases, but when the thickness of the negative electrode plate is controlled within 150 μm, fast charging performance may still be obtained for the battery.

Implementations of the present disclosure are described above. However, the present disclosure is not limited to the foregoing implementations. Any modification, equivalent replacement, or improvement made without departing from the spirit and principle of the present disclosure shall fall within the protection scope of the present disclosure.

What is claimed is:

1. A battery, comprising a positive electrode plate, a negative electrode plate, a separator, and a non-aqueous electrolyte solution, wherein the non-aqueous electrolyte solution comprises a non-aqueous organic solvent, an electrolyte salt, and an additive;
the non-aqueous organic solvent comprises ethyl methyl carbonate and/or ethyl propionate, and the additive comprises LiPO₂F₂;
a mass percentage of content of the ethyl methyl carbonate and/or ethyl propionate in a total mass of the non-aqueous organic solvent is A wt %;
a mass percentage of content of the LiPO₂F₂ in a total mass of the non-aqueous electrolyte solution is B wt %;
a thickness of the negative electrode plate is C, and measured in units of μm;
A, B, and C satisfy the following relational expression: A+100×B−C≥0; and
a discharge direct current internal resistance of the battery at 25° C. in an SOC of 50% is D; a discharge direct current internal resistance of the battery at 25° C. in an SOC of 80% is E; and D and E satisfy the following relational expression: E/D≤2.

2. The battery according to claim 1, wherein the mass percentage of content of the ethyl methyl carbonate and/or ethyl propionate in the total mass of the non-aqueous organic solvent is A wt %, wherein A wt %≥20 wt %.

3. The battery according to claim 2, wherein 80 wt %≥A wt %≥20 wt %.

4. The battery according to claim 1, wherein the non-aqueous organic solvent further comprises one or more of the following solvents: ethylene carbonate, propylene carbonate, dimethyl carbonate, diethyl carbonate, propyl acetate, n-butyl acetate, isobutyl acetate, n-amyl acetate, isoamyl acetate, propyl propionate, methyl butyrate, or ethyl n-butyrate.

5. The battery according to claim 1, wherein the electrolyte salt is selected from at least one of a lithium salt, a sodium salt or a magnesium salt.

6. The battery according to claim 5, wherein the lithium salt is selected from at least one of lithium hexafluorophosphate or lithium bis(fluorosulfonyl)imide; and/or
a content of the electrolyte salt in the electrolyte solution ranges from 1 mol/L to 2 mol/L.

7. The battery according to claim 1, wherein the mass percentage of content of the LiPO₂F₂ in the total mass of the non-aqueous electrolyte solution is B wt %, wherein B≤1 wt %.

8. The battery according to claim 7, wherein 0.05 wt %≤B wt %≤1 wt %.

9. The battery according to claim 1, wherein a decrease in conductivity of the electrolyte solution caused by addition of LiPO₂F₂ to the electrolyte solution is less than or equal to 1 mS/cm.

10. The battery according to claim 1, wherein conductivity of the electrolyte solution measured at 25° C. is greater than or equal to 7 mS/cm.

11. The battery according to claim 1, wherein the discharge direct current internal resistance D of the battery at 25° C. in the SOC of 50% is less than or equal to 65 mΩ; the discharge direct current internal resistance E of the battery at 25° C. in the SOC of 80% is less than or equal to 100 mΩ; and D and E satisfy the following relational expression: E/D≤2.

12. The battery according to claim 11, wherein D and E satisfy the following relational expression: 0.5≤E/D≤2.

13. The battery according to claim 12, wherein D and E satisfy the following relational expression: 1≤E/D≤1.8.

14. The battery according to claim 12, wherein D and E satisfy the following relational expression: 1.2≤E/D≤1.6.

15. The battery according to claim 1, wherein the non-aqueous electrolyte solution further comprises one or more of the following additives: vinylene carbonate, vinyl ethylene carbonate, fluoroethylene carbonate, ethylene sulphite, methylene methanedisulfonate, ethylene sulfate, succinonitrile, glutaronitrile, adiponitrile, pimelic dinitrile, suberonitrile, sebaconitrile, 1,3,6-hexanetrinitrile, 1,2-bis(2-cyanoethoxy)ethane, 3-methoxypropionitrile, 1,3-propanesultone, or propenyl-ene-1,3-sultone.

16. The battery according to claim 1, wherein the thickness C of the negative electrode plate is less than or equal to 150 μm.

17. The battery according to claim 16, wherein a ratio of a thickness of the positive electrode plate to the thickness of the negative electrode plate is (0.93−1.48):1.

18. The battery according to claim 1, wherein the positive electrode plate comprises a positive electrode current collector and a positive electrode active material layer coated on a surface of either or both sides of the positive electrode current collector; and the positive electrode active material layer comprises a positive electrode active material, a conductive agent, and a binder.

19. The battery according to claim 18, wherein the positive electrode active material is selected from one or more of a layered-lithium transition metal composite oxide, lithium manganate, or a ternary material mixed with lithium cobaltate.

20. The battery according to claim 19, wherein the layered-lithium transition metal composite oxide has a chemical formula of Li₁₊ₓNi_{y}Co_{z}M_{(1-y-z)}O₂, wherein −0.1≤x≤1, 0≤y≤1, 0≤z≤1, and 0≤y+z≤1; and M is one or more of Mg, Zn, Ga, Ba, Al, Fe, Cr, Sn, V, Mn, Sc, Ti, Nb, Mo, or Zr.
